(19) United States
(12) Patent Application Publication
(10) Pub. No.: US 2008/0244435 A1
(43) Pub. Date: Oct. 2, 2008

(54) Computer Readable Medium Recording an Information Providing Program, Information Providing Device, and Method for Providing Information

(75) Inventor: Noriyuki Takei, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/055,117

(22) Filed: Mar. 25, 2008

(30) Foreign Application Priority Data
Mar. 28, 2007 (JP) 2007-084517
Jan. 15, 2008 (JP) 2008-005547

(51) Int. Cl. G06F 3/048

(52) U.S. Cl. 715/771

(57) ABSTRACT

The present invention provides a computer readable medium recording an information providing program for providing information relating to an optional device installable on an apparatus such as a printer, the program being capable of providing the information on an installable optional device that is presently uninstalled to a user in an easily understandable form. In the information providing program causing the information providing device to execute: acquiring information relating to the installation status of the optional device on the target apparatus and determining an uninstalled optional device, which is an installable optional device that has not been installed; determining whether the uninstalled optional device can be additionally installed in the installation status in the target apparatus; and displaying an image representing the uninstalled optional device to a user so that possibility or impossibility of the additional installing can be identified.

### CROSS-REFERENCE TO RELATED APPLICATIONS

This application is based upon and claims the benefit of priority from the prior Japanese Patent Application No. 2007-84517, filed on Mar. 28, 2007, and the prior Japanese Patent Application No. 2008-5547, filed on Jan. 15, 2008, the entire contents of which are incorporated herein by reference.

### BACKGROUND OF THE INVENTION

1. Field of the Invention

The present invention relates to a computer readable medium recording a program or the like for providing information relating to an optional device installable on an apparatus such as a printer, and more particularly to a computer readable medium recording an information providing program or the like that can provide information, to a user in an easily understandable form, relating to an installable optional device that is presently uninstalled.

2. Description of the Related Art

Typically optional devices that can be optionally installed are prepared for apparatuses such as printers and copiers. For example, in the case of a printer, a plurality of memory units of different capacity, HDD units, a plurality of paper feeders for expansion, and duplex printing mechanisms are prepared as optional devices.

For example, in the case of a printer, information as to whether these optional devices have been installed on the apparatus is provided by a printer driver provided in the host device. More specifically, when bidirectional communication is possible between the host device and printer, the printer driver acquires information on the installed optional device from the printer and displays the names of the installed optional devices in the list format. Furthermore, when the bidirectional communication is impossible, the installation status of the optional devices is inputted by the user into the host device and set to the printer driver, and this set information is similarly displayed in the list format. Such information is displayed on an optional settings window for performing settings and display with respect to detailed items, rather than on the basic settings window for performing setting and display with respect to basic items, from among the user interface windows prepared to perform the setting of various conditions relating to printing in the printer.

Such provision of information relating to the optional devices is described, for example, in Japanese Patents Nos. 3017605 and 3740216 and Japanese Patent Laid-open No. 2004-21400. Japanese Patent No. 3017605 discloses a configuration in which the installation status of an optional device is indicated by an external appearance image, Japanese Patent No. 3740216 discloses a feature of changing the displayed contents according to the installation status of an optional device, and Japanese Patent Laid-open No. 2004-21400 discloses a feature of automatically acquiring configuration information for the printer.

However, with the above-described conventional methods for providing information relating to an optional device, the attention is focused on the presently installed optional device, and the information relating to an installable optional device that has not been installed is not provided to the user in an easily understandable form.

Such lack of easily understandable information that relates to the uninstalled optional device is inconvenient when the user tries to find a way of using the optional device effectively and conveniently in an apparatus such as a printer, is hardly useful as an incentive for purchasing new optional devices, and causes the suppliers of apparatuses such as a printers to miss a chance of selling the optional device.

### SUMMARY OF THE INVENTION

Accordingly, it is an aspect of the present invention to provide a computer readable medium recording an information providing program that provides an information relating to an optional device installable on an apparatus such as a printer, this program being capable of providing information relating to an installable optional device that is presently uninstalled to a user in an easily understandable form or the like.

In order to attain the above-described aspect, one gist of the present invention resides in a computer readable medium recording an information providing program for causing an information providing device to execute a processing of providing information relating to an optional device installable on a target apparatus, the program causing the information providing device to executes: acquiring information relating to the installation status of the optional device on the target apparatus and determining an uninstalled optional device, which is an installable optional device that has not been installed; determining whether the uninstalled optional device can be additionally installed in the installation status in the target apparatus; and displaying an image representing the uninstalled optional device to a user so that the possibility or impossibility of the additional installing can be identified.

In a preferred mode of the above-described invention, the image representing the optional device that has been installed on the target apparatus is also displayed to the user so that the installed optional device can be distinguished from the uninstalled optional device.

In another preferred mode of the above-described invention, the external appearance image of the target apparatus including the optional device that has been installed on the target apparatus is also displayed to the user.

In yet another mode of the above-described invention, when a plurality of identical optional devices can be installed on the target apparatus, the determination of the uninstalled optional device, the determination of whether the uninstalled optional device can be added, and the display of the image are preformed with respect to the plurality of optional devices respectively.

In yet another preferred mode of the above-described invention, an interface window which has a basic settings window and a detail settings window and which serves for the user to perform a setting operation for the target apparatus is provided by the information providing device, and the display of the image representing the uninstalled optional device is performed on the basic settings window.

In yet another mode of the above-described invention, the target apparatus is a printer, and the information providing device is a host device of the printer or the printer.

In order to attain the above-described aspect, another gist of the present invention resides in an information providing device that provides information relating to an optional device installable on a target apparatus, the information providing device having an information acquisition unit which acquires information relating to the installation status of the optional device on the target apparatus, determines an uninstalled optional device, which is an installable optional device that has not been installed, and determines whether the uninstalled optional device can be additionally installed in the installation status in the target apparatus; and an information display unit which displays an image representing the uninstalled optional device to a user so that the possibility or impossibility of the additional installing can be identified.

In order to attain the above-described aspect, yet another gist of the present invention resides in a method for providing information in an information providing device that provides information relating to an optional device installable on a target apparatus, the method having a step in which the information providing device acquires information relating to the installation status of the optional device on the target apparatus and determines an uninstalled optional device, which is an installable optional device that has not been installed; a step in which the information providing device determines whether the uninstalled optional device can be additionally installed in the installation status in the target apparatus; and a step in which the information providing device displays an image representing the uninstalled optional device to a user so that the possibility or impossibility of the additional installing can be identified.

Other aspects and features of the present invention will become obvious from the embodiments of the invention described hereinbelow.

### BRIEF DESCRIPTION OF THE DRAWINGS

FIG. 1 is a hardware configuration diagram of an embodiment of the information providing device employing the present invention;

FIG. 2 is a functional structural diagram of the host computer 1 and printer 2;

FIG. 3 is a flowchart illustrating a sequence of display processing on the basic settings window;

FIG. 4 illustrates an example of optional information that will be stored;

FIG. 5 illustrates an example of the basic settings window;

FIG. 6 illustrates the icons of the optional devices and external appearance images displayed in another example; and

FIG. 7 illustrates another display example of the icons of the optional devices and external appearance images.

### DESCRIPTION OF THE PREFERRED EMBODIMENTS

Embodiments of the present invention will be described below with reference to the appended drawings. However, the technical scope of the present invention is not limited to the embodiments. In the figures, identical or similar components are assigned with identical reference numerals or reference symbols.

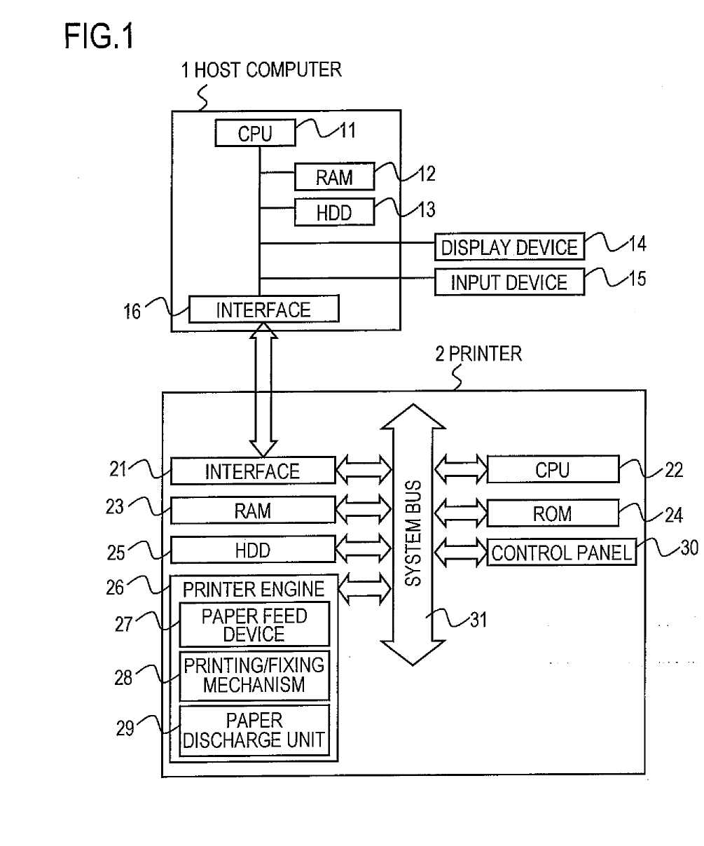

FIG. 1 is a hardware structural diagram relating to an embodiment of an information providing device employing the present invention. A host computer 1 shown in FIG. 1 is an information providing device employing the present invention, and provides information relating to an optional device to a user in the form that is easy to understand by displaying of a driver for a printer 2 connected to the device an image of the optional device that can be installed on the printer 2 in a basic settings window for printing settings, so that the possibility of additional installing the optional device, without removing the optional device that is presently installed, can be identified.

In the present embodiment, an apparatus for installing the optional device is the printer 2 shown in FIG. 1, and the information relating to the optional device is provided to the user on the host computer 1.

The host computer 1 can have a typical personal computer configuration, and as shown in FIG. 1, hardware therefor includes a CPU 11, an RAM 12, an HDD 13, an interface 16 for external devices, a display device 14 as a monitor, and an input device 15 such as a keyboard or a mouse.

Further, the printer 2 is, as one example, a laser printer, and hardware therefor includes an interface 21 for the host computer 1, a CPU 22, an RAM 23, an ROM 24, an HDD 25, a printer engine 26, a control panel 30, and a system bus 31, as shown in FIG. 1. The printer engine 26 is a unit for executing printing on a printing medium and includes a paper feed device 27 such as a paper cassette for feeding the printing medium, a printing/fixing mechanism 28 serving to execute the printing, and a paper discharge unit 29 for discharging the printing medium after printing.

Further, as described hereinabove, several optional devices can be installed on the printer 2. Thus, in addition to the devices provided by default for the memory such as RAM 23, HDD 25, paper feed device 27, and paper discharge unit 29, various optional devices such as an expansion memory, an HDD, a paper feed device, and a paper discharge units are prepared to improve functionality. A duplex printing mechanism is another example of optional device.

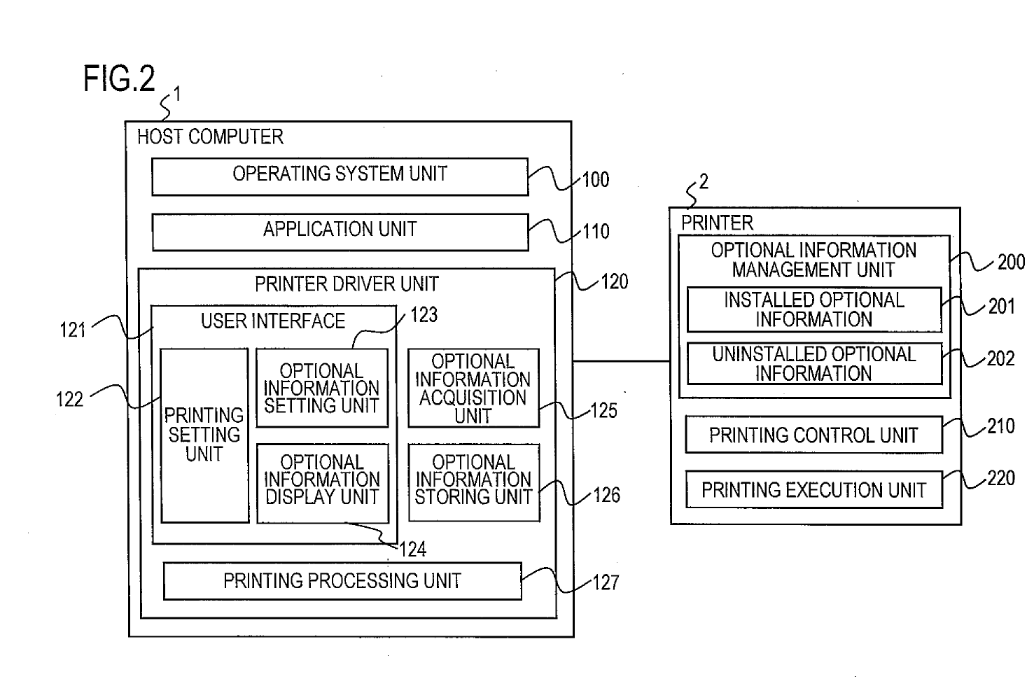

FIG. 2 is a functional structural diagram of the host computer 1 and printer 2. As shown in FIG. 2, functionally, the host computer 1 is equipped with an operating system unit 100, an application unit 110, and a printer driver unit 120.

The application unit 110 is a portion that issues a request to print something created with the printer 2 and, for example, is composed of a document creating software.

The printer driver unit 120 is a driver for the printer 2 and is composed of a driver program stored in the HDD 13 or the like, the CPU 11 that executes the processing according to the program and the like. As shown in FIG. 2, the printer driver unit 120 comprises a user interface 121 having a printing setting unit 122 for the user to perform various settings such a printing conditions of the printer 2, and a printing processing unit 127 that receives a printing request from the application unit 110, generates printing data corresponding to the printing conditions, sends the printing data to the printer 2, and performs printing designation.

The printer driver unit 120 has a function of providing information relating to an optional device of the printer 2 and comprises an optional information setting unit 123 and optional information display unit 124 of the user interface 121, an optional information acquisition unit 125, and an optional information storing unit 126, as shown in FIG. 2, for realizing the aforementioned function.

The optional information setting unit 123 is a component that enables the information input by the user with respect to the installation status of the optional device of the printer 2. The optional information acquisition unit 125 is a component that performs a processing of acquiring the information relating to the installation status of the optional device from the printer 2. Further, the optional information storing unit 126 is a component that stores the optional information acquired by the optional information setting unit 123 and optional information acquisition unit 125. The optional information display unit 124 is a components that displays to the user the optional information stored in the optional information storing unit 126. Specific features are inherent to the processing of providing the information relating to the optional device that is performed in these four components, and the specific contents of such processing will be described below. The program portion performing the functions of these four components are equivalent to information providing program employing the present invention. The program of printer driver unit 120 may be installed on the host computer 1 from a CD or other recording media on which it is stored, or may be downloaded to the host computer 1 from a prescribed site via the Internet or another network.

As shown in FIG. 2, functionally, the printer 2 includes an optional information management unit 200, a printing control unit 210, and a printing execution unit 220. The printing control unit 210 is the so-called controller that receives the printing data sent from the host computer 1, implements the predetermined data processing, and then transfers the data to the printing execution unit 220 and performs printing designation. The printing execution unit 220 is equivalent to the printer engine 26 and executes printing on the printing medium according to the printing designation.

The optional information management unit 200 is a component that manages information relating to the optional device installable on the printer 2. This component detects the installation status of the optional device at a predetermined timing and saves the installed optional information 201, which is the information relating to the installed optional device, and uninstalled optional information 202, which is the information relating to the uninstalled optional device. These kinds of information are transmitted in response to a request from the optional information acquisition unit 125 of the host computer 1. Further, the installed optional information 201 and uninstalled optional information 202 are also saved in the RAM 23 or the like, and the optional information management unit 200 is actuated by the operation of the CPU 22 according to the program stored in the ROM 24, as part of the controller. Further, it is also possible not to save the uninstalled optional information 202.

Providing information relating to the optional device to the user in the host computer 1 is a specific feature of the host computer 1 and printer 2 of the present embodiment that has the above-described configuration, and the specific contents of this operation will be described below.

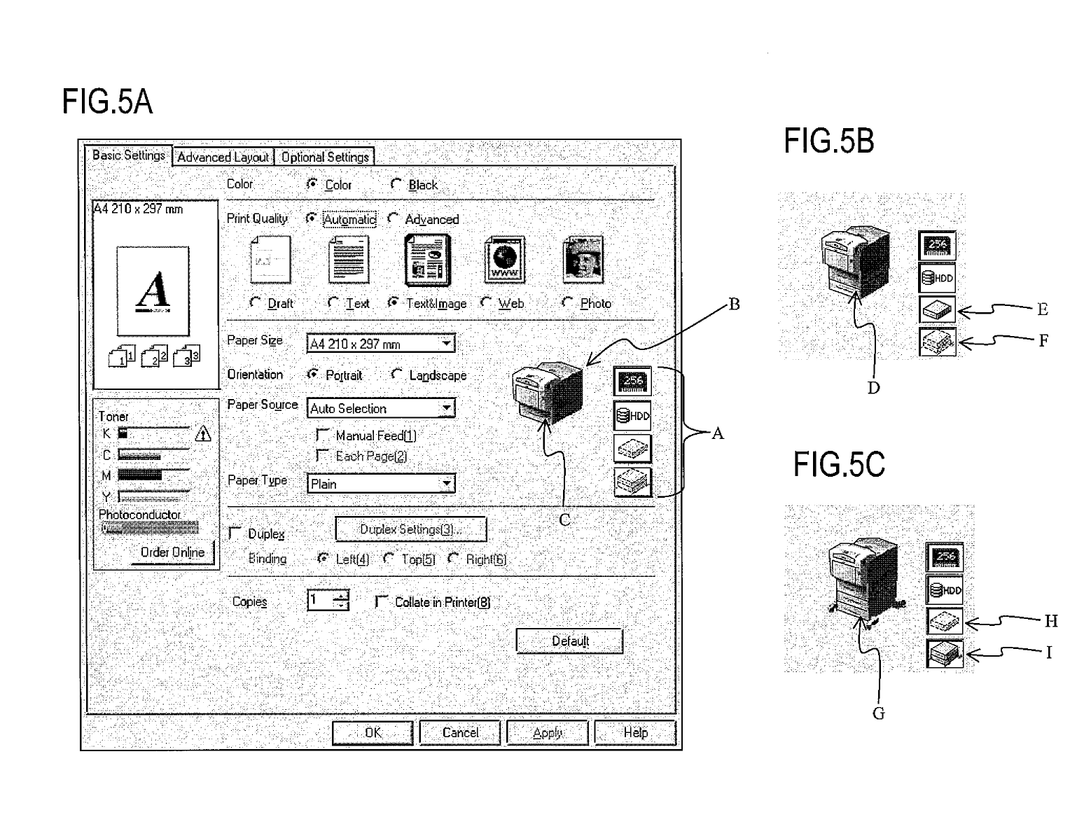

The printer driver unit 120 prepares setting windows for the user to perform various settings of the printer 2, and a basic settings window for performing settings with respect to basic items relating to printing and a plurality of detailed settings windows for performing settings relating to detailed items or special items of printing or performing settings relating to the printing environment (presence of an optional device, and the like) are prepared as the setting windows. Because the specific feature is in providing information relating to the optional device, this operation being performed with the basic settings window, the display processing of the basic settings window will be explained below. In the basic settings window, the present setting contents can be browsed and the settings can be changed with respect to items, for example, such as the printing quality, paper size, and paper type. Further, in the Advanced Layout Tab Window shown in FIG. 5A that is the detailed settings window, the items such as page layout and page decoration at printing can be changed. In the Optional Settings Tab Window shown in FIG. 5A that is the detailed settings window, settings relating to the optional devices can be done and the settings can be made of verified.

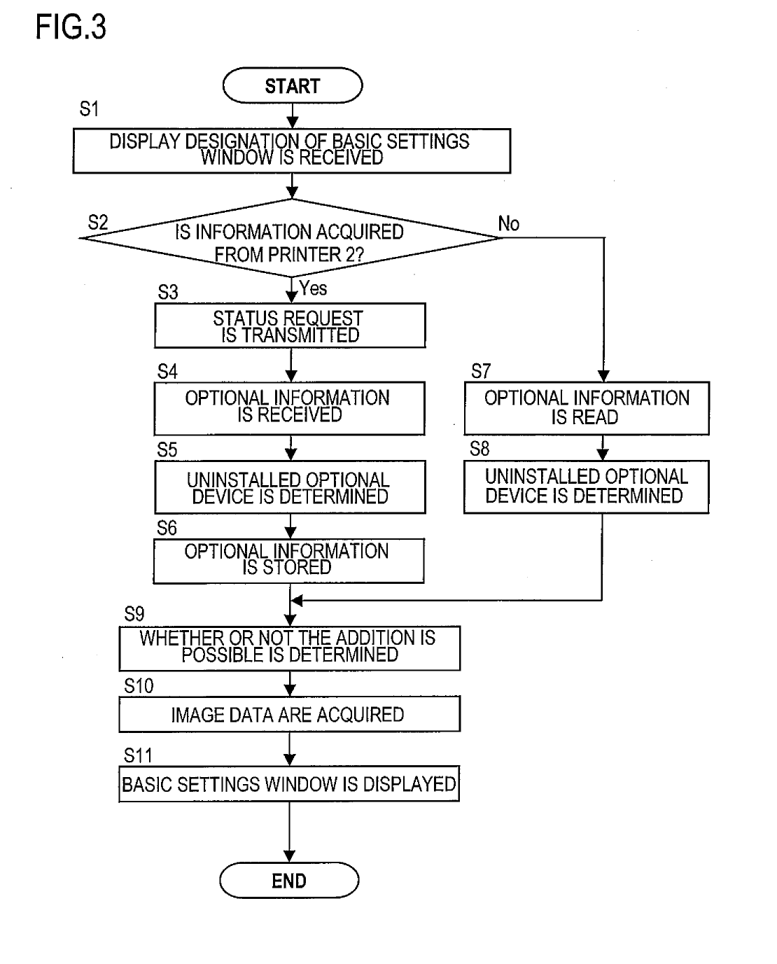

FIG. 3 is a flowchart illustrating an example of display processing sequence for the basic settings window. First, the user performs the display designation of the basic settings window. More specifically, the display designation of the basic settings window can be performed by an operation of selecting a property menu of the printer 2 from the window for the printing request provided by the application unit 110, or by selecting a printing setting menu from the user interface window provided by the printer driver unit 120.

The display designation of the basic settings window is received by the user interface unit 121 of the printer driver unit 120 (step S1) and then, it is determined whether the information acquisition from the printer 2 is performed (step S2). Here, the printer driver unit 120 may determine whether the information acquisition is performed by referring to the contents that has been set by the user in advance, or may determine that the information acquisition is performed when the bidirectional communication can be conducted between the host computer 1 and printer 2 and that the information acquisition is not performed when the bidirectional communication is impossible.

When the information acquisition from the printer 2 is determined to be performed (Yes in step S2), the printer driver unit 120 sends a status request to the printer 2 (step S3). The status request is a request relating to the present status of the printer 2. In response to this request, the printer 2 returns status information of various kinds to the host computer 1. The status information includes the above-described installed optional information 201 and uninstalled optional information 202 saved in the optional information management unit 200 of the printer 2.

The optional information acquisition unit 125 receives the installed optional information 201 and uninstalled optional information 202 of the status information that has been sent (step S4). Based on these types of information, the optional information acquisition unit 125 determines an installable optional device that is presently not installed on the printer 2 (that is, the uninstalled optional device) (step S5).

Here, when the uninstalled optional information 202 is received, the uninstalled optional device is confirmed by this information. Therefore, the uninstalled optional device is determined by the transmission of this information. On the other hand, when the uninstalled optional information 202 is not stored in the printer 2 and only the installed optional information 201 is received, the uninstalled optional device is determined by comparing a list of all optional devices installable on the printer 2 that has been saved in advance in the printer driver unit 120 and a list of presently installed optional devices that are indicated by the installed optional information 201.

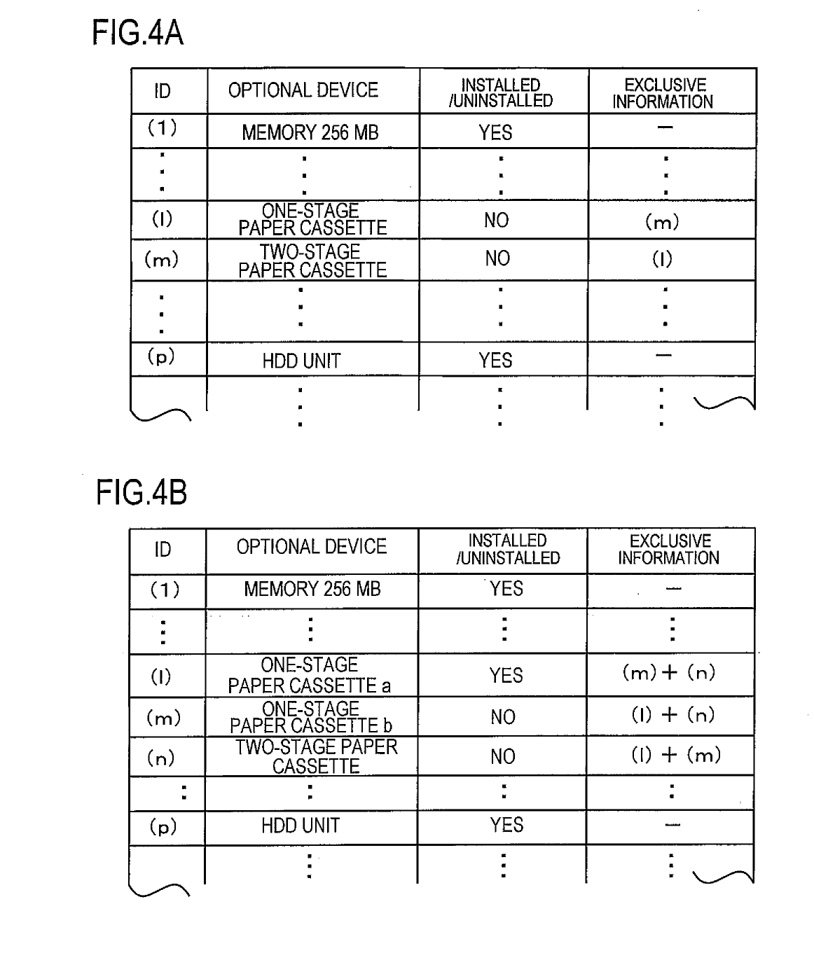

Then, the optional information storing unit 126 stores the optional information obtained by the reception of information and determination of the uninstalled optional device in a registry of the operating system unit 100 (step S6). More specifically, whether or not the installation on the printer 2 has been performed is recorded for each of all the optional device that can be installed on the printer 2. FIG. 4 shows an example of the stored information.

In the two tables shown in FIG. 4, the “ID” at the left end indicates identification information of the optional device installable on the printer 2. The “Optional Device” of the second column indicates the name of the optional device installable on the printer 2, and the “Installed/Uninstalled” of the third column indicates whether each optional device has been installed on the printer 2. Such information is stored in the registry of the operating system unit 100, and the information relating to the “Installed/Uninstalled” status is updated when the optional information is recorded to match the present installation status.

In the example shown in FIG. 4A, a 256 MB memory and an HDD unit have been installed on the printer 2, whereas a one-stage paper cassette and a two-stage paper cassette have not been installed on the printer 2, that is, they are the uninstalled devices. In the example shown in FIG. 4B, the configuration is shown in which two one-stage paper cassettes (a, b) can be installed at the same time.

On the other hand, when the information is determined in step S2 not to be acquired from the printer 2 (No in step S2), the optional information acquisition unit 125 reads the optional information that is presently stored in the registry of the operating system unit 100 (step S7) and determines the uninstalled optional device according to the information that was read out (step S8). Thus, an optional device that is considered not to be installed on the printer 2 based on the stored optional information is determined as the uninstalled optional device.

When bidirectional communication between the host computer 1 and printer 2 is impossible, the stored optional information can be appropriately updated by the user. More specifically, when the installation status of the optional device is changed, for example, by installing the optional device anew on the printer 2, the user can make the update by performing an operation of setting this installation status in the predetermined location prepared in the above-described detailed settings window (Optional Settings Tab Window shown in FIG. 5A). In this case, the optional information setting unit 123 makes the update so that the optional information stored in the register matches the newest installation status based on the information inputted by the aforementioned user's operations.

Where the uninstalled optional device is thus determined for each case (S5, S8), the optional information acquisition unit 125 determines whether the optional device can be additionally installed without removing the optional device that is presently installed (step S9). More specifically, this decision is made based on the exclusive information on each optional device that is stored by the host computer 1. This exclusive information can be linked to the aforementioned “Installed/Uninstalled” information and stored, e.g., in the registry of the operation system unit 100.

The “Exclusive Information” at the right end of FIG. 4 shows such exclusive information. In the examples shown in FIGS. 4A and B, one device for the memory (256 MB memory) can be installed and one device for HDD unit can be installed, regardless of other optional devices. As for the paper feeder, in the example shown in FIG. 4A, one cassette from among the one-stage paper cassette and two-stage paper cassette can be installed. In the example shown in FIG. 4B, up to two one-stage paper cassettes, or up to one two-stage paper cassette and one one-stage paper cassette can be installed.

Therefore, in FIG. 4A, the one-stage paper cassette (l) cannot be installed in the case where the two-stage paper cassette (m) has been installed. In other words, in the case where the one-stage paper cassette (l) has been installed, the two-stage paper cassette (m) cannot be installed. Accordingly, the “Exclusive Information” of the one-stage paper cassette becomes “(m)” that indicates the two-stage paper cassette. At the same time, the “Exclusive Information” of the two-stage paper cassette becomes “(l)” that indicates the one-stage paper cassette (l).

Further, in FIG. 4B, the first one-stage paper cassette a(l) cannot be directly added or installed in the case where both the second one-stage paper cassette b(m) and the two-stage paper cassette (n) have been installed. In other words, where the one-stage paper cassette a(l) has been installed, both of the second one-stage paper cassette b(m) and the two-stage paper cassette (n) cannot be added or installed. Accordingly, the “Exclusive Information” of the first one-stage paper cassette becomes “(m)+(n)”. At the same time, the “Exclusive Information” of the second one-stage paper cassette b(m) and the two-stage paper cassette (n) becomes “(l)+(n)” and “(l)+(m)”, respectively.

The optional information acquisition unit 125 determines whether each uninstalled optional device can be added to the present installation status based on the “Exclusive Information” and the above-described present “Installed/Uninstalled” information. In the examples shown in FIG. 4A, the optional devices indicated by the exclusive information with respect to the one-stage paper cassette (l) and two-stage paper cassette (m) have not been installed. Therefore, it is determined that these cassettes can be installed. Further, in the example shown in FIG. 4B, although the one-stage paper cassette a(l) has been installed, not all the optional devices indicated by the exclusive information with respect to the one-stage paper cassette b(m) and two-stage paper cassette (n) have been installed. Therefore, it is determined that these cassettes can be added.

In FIG. 4, only one memory of one kind can be installed, but this is merely an example, and a plurality of memory devices of a plurality of kinds may be also installed at the same time.

Then, the optional information display unit 124 acquires data on the images displayed with respect to each optional device (step S10). More specifically, data on icons of optional devices and data representing the external appearance images of the installed optional devices in a state of installation on the printer 2 are acquired.

Here, the icons of optional devices are basically of four kinds: those representing the case in which the optional device has been installed and the addition is impossible, those representing the case in which the optional device has been installed and the addition is possible, those representing the case in which the optional device is uninstalled and the addition is impossible, and those representing the case in which the optional device is uninstalled and the addition is possible, and data corresponding to these icons are stored in a readable format in the host computer 1 with respect to all the optional devices that can be installed on the printer 2. However, when the icon data are stored with respect to each of identical optional devices such as the above-described one-stage paper cassette a(l) and one-stage paper cassette b(m) shown in FIG. 4B, the case in which they can be installed and the addition is possible is excluded. Therefore, data of three kinds may be stored. Further, depending on the conditions of the above-described exclusive information, there may be optional devices for which the data of two kinds can be stored. For such devices, it is possible to store only two kinds of data. The data on the external appearance image in the installed state are stored in advance in the host computer 1 according to the installation status of the optional device.

The optional information display unit 124 recognizes the status (installed, uninstalled, can be added, cannot be added) with respect to each optional device based on the determination of the uninstalled optional device (S5, S8) and the determination of the possibility of addition (S9) performed by the optional information acquisition unit 125, and selects and acquires the data on icons representing the respective status for each optional device.

The display data relating to the optional information in the basic settings window is prepared by data acquisition (S10). With respect to other information displayed on the basic settings window, the display data are also prepared from the received status information and information that has been set in advance in the host computer 1. Once the display preparation of the basic settings window is completed, the user interface unit 121 displays the basic settings window on the display device 14 based on the prepared data (step S11). The image of the optional device and the external appearance image is displayed within the basic settings window by the optional information display unit 124.

FIG. 5 shows an example of the displayed basic settings window. FIG. 5A shows the display basic settings window relating to the case shown in FIG. 4A. In this example, the optional devices that can be installed on the printer 2 are only the 256 MB memory, HDD unit, one-stage paper cassette, and two-stage paper cassette.

The portion represented by A in the figure shows the icons of optional devices. Here, the icons of the 256 MB memory, HDD unit, one-stage paper cassette, and two-stage paper cassette are displayed in the order of description from above. The displayed icons are based on the selected and acquired data. The icon relating to the installed optional device is shown by a dark color, and that relating to the uninstalled optional device is shown by a light color. A raised icon (convex icon) is displayed for the device that can be added, and the sunk icon (concave icon) is displayed for the device that cannot be added. As shown in FIG. 4A, the 256 MB memory and HDD unit have been installed and cannot be added. Therefore, they are displayed by sunk icons of dark color. On the other hand, the one-stage paper cassette and two-stage paper cassette are uninstalled and can be added. Therefore, raised icons of light color are displayed therefor.

Any images of the optional devices represented by icons may be employed, provided that the optional devices can be easily recognized by the user. Thus, abstract drawings of the devices, detailed illustrations, actual photographic images, rows of symbols representing the names, or combinations thereof can be employed. Further, the installed and uninstalled optional devices are represented by dark and light colors, and the devices that can and cannot be added are represented by concave and convex images, respectively. However, such representation is not limiting, and colors, shapes, or combinations thereof may be used for recognition.

Symbol B in FIG. 5A shows an external appearance image of the printer 2 including the installed optional device. In this external appearance image, symbol C shows the installed paper feeder; here, because a paper feeder is not installed as the optional device, only the basic paper feeder is displayed. Further, the icon (A) of the optional device is displayed on the periphery of (close to) the external appearance image (B).

The icons of the optional devices and external appearance image are displayed based on the data on images acquired by the optional information display unit 124.

FIG. 5B is a display example of the optional devices and external appearance images in the basic settings window in the case where the one-stage paper cassette (l) has been installed in the example shown in FIG. 4A. In this case, the icons of the one-stage paper cassette and two-stage paper cassette are displayed so as to be shown in portion E and portion F, respectively, in the figure. Thus, comparing to FIG. 5A, the icon of the one-stage paper cassette is changed to a dark color, and the icons of the one-stage paper cassette and two-stage paper cassette are changed to a concave shape because the addition is impossible. An external appearance image of the installed one-stage paper cassette is shown in portion D in the figure.

FIG. 5C is a display example of the optional devices and external appearance images in the basic settings window in the case where the two-stage paper cassette (m) has been installed in the example shown in FIG. 4A. In this case, the icons of the one-stage paper cassette and two-stage paper cassette are displayed so as to be shown in portion H and portion I, respectively, in the figure. Thus, comparing to FIG. 5A, the icon of the two-stage paper cassette is changed to a dark color, and the icons of the one-stage paper cassette and two-stage paper cassette are changed to a concave shape because the addition is impossible. An external appearance image of the installed two-stage paper cassette is shown in portion G in the figure.

Thus, in the basic settings window, images are displayed for all the optional devices that can be installed on the printer 2, in such a form that whether the optional devices have been installed/uninstalled and can be installed/uninstalled can be recognized.

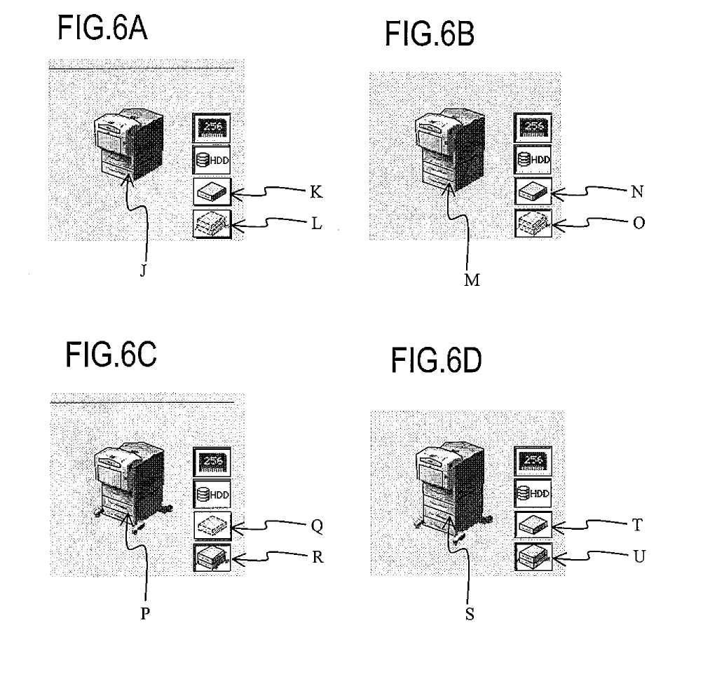

FIG. 6 shows the optional device icons and external appearance images displayed in another example. FIG. 6A is a display at the basic settings window that is displayed in the case shown in FIG. 4B. In this example, the optional devices that can be installed on the printer 2 are only the 256 MB memory, HDD unit, two one-stage paper cassettes (a, b), and two-stage paper cassette; the one-stage paper cassettes are displayed by one icon.

The icon of the one-stage paper cassette shown by symbol K in the figure is displayed by a dark color because the one-stage paper cassette (a) from among the two one-stage paper cassettes (a, b) has been installed, as shown in FIG. 4B. Further, because one more one-stage paper cassette (one-stage paper cassette (b)) can be added and installed in this state, the icon is convex. Further, the icon of the two-stage paper cassette shown by symbol L in the figure is displayed by a light color and a convex shape because the cassette is not installed, but can be added and installed as shown in FIG. 4B. Further, the external appearance image of the installed one-stage paper cassette is displayed by symbol J in the figure.

FIG. 6B is a display example relating to the case in which two one-stage paper cassettes (a, b) have been installed in the example shown in FIG. 4B. In this state, as described above, because the additional paper feeder cannot be installed, the icon of the one-stage paper cassette and the icon of the two-stage paper cassette, which are shown by N and O respectively in the figure, are displayed by concave shapes. Further, the external appearance images of the installed two one-stage paper cassettes are displayed by symbol M in the figure.

FIG. 6C is a display example relating to the case in which a two-stage paper cassette has been installed in the example shown in FIG. 4B. In this state, as described above, because one one-stage paper cassette can be added, the icon of the one-stage paper cassette shown by symbol Q in the figure is displayed by a convex shape. On the other hand, the icon of the two-stage paper cassette shown by symbol R in the figure is displayed by a concave shape. Further, the external appearance image of the installed two-stage paper cassette is displayed by symbol P in the figure.

FIG. 6D is a display example relating to the case in which one one-stage paper cassette and a two-stage paper cassette have been installed in the example shown in FIG. 4B. In this state, as described above, because the additional paper feeder cannot be installed, the icon of the one-stage paper cassette and the icon of the two-stage paper cassette that are shown by symbols T and U, respectively, in the figure are displayed by concave shapes. Further, the external appearance images of the installed one one-stage paper cassette and two-stage paper cassette are displayed by symbol S in the figure.

The display processing of the basic settings window is thus performed in the host computer 1.

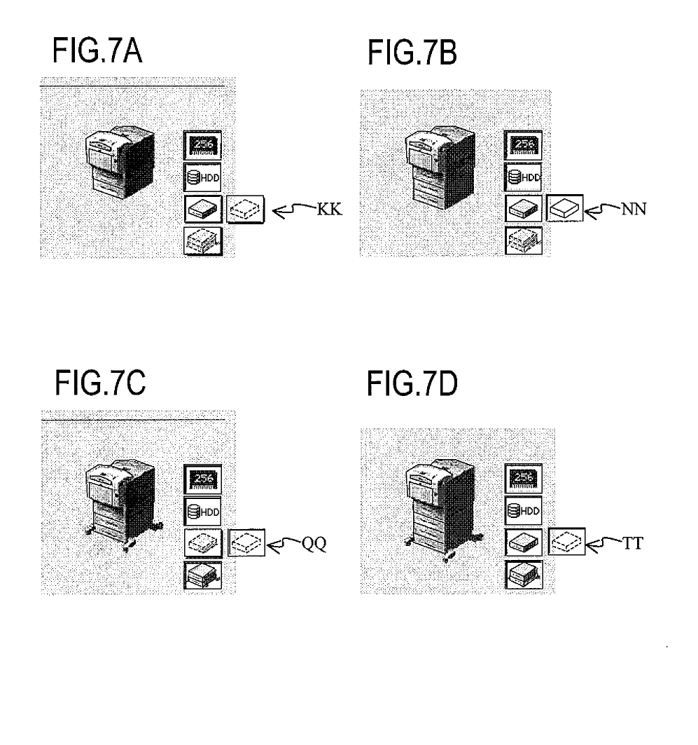

In the display shown in FIG. 6, the two one-stage paper cassettes that can be installed are displayed by one icon, but each one-stage paper cassette may be also displayed by its own icon. Thus, the icon of the one-stage paper cassette (a) and the icon of the one-stage paper cassette (b) may be displayed. FIG. 7 illustrates a display example relating to such case.

FIG. 7A to FIG. 7D are displayed in the states identical to those shown in FIG. 6A to FIG. 6D, respectively. The state displayed in FIG. 7A is identical to that shown in FIG. 6A, but two icons corresponding to two one-stage paper cassettes are displayed, as shown by symbols KK in the figure. Because only the one-stage paper cassette (a) is installed, the left icon corresponding thereto is displayed by a dark color and a concave shape. On the other hand, the one-stage paper cassette (b) is uninstalled and can be added. Therefore, the icon corresponding thereto is represented by a light color and a convex shape.

As for FIG. 7B to FIG. 7D, icons illustrating the state of each one-stage paper cassette are similarly displayed, as respectively shown by symbols NN to TT in the figure.

Thus, when a plurality of identical optional devices can be installed at the same time, the corresponding number of icons may be displayed and the respective state of each device may be represented.

In the present embodiment, the image of the optional device and the external appearance image of the printer 2 are displayed on the basic settings window, but the image of the optional device and the external appearance image of the printer 2 may be also displayed on the detailed settings window or on both the basic settings window and the detailed settings window.

The external appearance image of the printer 2 is displayed on the basic settings window, but it is also possible not to display the external appearance image.

In the basic settings window, the images are displayed with respect to all the installable optional derives, but it is also possible to display images only with respect to the uninstalled devices. However, in the case where a plurality of identical optional devices can be installed, as the one-stage paper cassettes in the example shown in FIG. 6, when the optional devices have been installed, but the maximum possible number thereof have not been installed, it is preferred that these optional devices be included in the display as uninstalled optional devices.

Further, in the above-described embodiment, the display of the basic settings window is performed at the host computer 1, but it may be also performed at the printer 2. In such case, the controller of the printer 2 performs processing identical to that of the printer driver unit 120 and displays a similar basic settings window on the display of the control panel 30 of the printer 2. Further, in this case, the image data of the icon and external appearance image of the uninstalled optional device are preferably stored in the printer 2.

Further, in the above-described embodiment, the printer 2 is a laser printer, but it may be a printer of another printing system.

As described hereinabove, in the information providing device of the present embodiment, at least the information on the installable optional device that is presently uninstalled (uninstalled optional device) is displayed as an image on the user interface window with respect to the optional devices of the target apparatus in the form that makes it possible to recognize whether the optional device can be additionally installed, at the present installation state. Therefore, the user can easily understand about the uninstalled optional device including whether the uninstalled optional device is used as a replacement for the optional device that has already been installed, the effective usage of the target apparatus using optional devices is facilitated, and, therefore, the probability of purchasing optional equipment can be increased. In addition, because the uninstalled optional device is displayed as an image, it can be easily understood by anybody, regardless of the language used, and it is not necessary to change the interface for the respective portion for each country of use.

Further, in the present embodiment, the external appearance image of the target apparatus including the installed optional device is also displayed, and the image of the uninstalled optional device is displayed on the periphery of (close to) the external appearance image. Therefore, the user can easier understand the installation of the uninstalled device.

Further, in the present embodiment, images for all the installable optional devices, including the optional devices that have already been installed, are displayed so that the user can recognize whether or not the device has been installed. As a result, the user can easier understand the status of optional devices and the installable optional devices.

In addition, as described above, when a plurality of identical optional devices can be installed at the same time, the respective number of icons can be displayed and the state of each optional device can be displayed. As a result, the information can be provided in a form such that can be easier understood by the user.

Because the images of the optional devices are displayed on the basic settings window, detailed settings window, or both windows, the information relating to the optional devices can be provided in a form such that can be easier understood by the user.

Further, in the present embodiment, because the target apparatus where the optional device is installed is a printer and a wide range of optional devices can be installed, it conforms to the application aspect of the present invention, but the target apparatus is not limited to the printer and can be another apparatus having optional devices, for example a copier.

The protection scope of the present invention is not limited to the above-described embodiments and includes the inventions described in the claims and equivalents thereof.

What is claimed is:

1. A computer readable medium recording an information providing program for causing an information providing device to execute a processing of providing information relating to an optional device installable on a target apparatus;
said program causing said information providing device to execute:
acquiring information relating to an installation status of the optional device on said target apparatus and determining an uninstalled optional device, which is an installable optional device that has not been installed;
determining whether said uninstalled optional device can be additionally installed in the installation status in said target apparatus; and
displaying an image representing said uninstalled optional device to a user so that possibility or impossibility of said additional installing can be identified.

2. The computer readable medium according to claim 1, wherein the image representing the optional device that has been installed on said target apparatus is also displayed to the user so that said installed optional device can be distinguished from said uninstalled optional device.

3. The computer readable medium according to claim 1 or 2, wherein an external appearance image of said target apparatus including said optional device that has been installed on said target apparatus is also displayed to the user.

4. The computer readable medium according to claim 1, wherein when a plurality of identical optional devices can be installed on said target apparatus, said determination of the uninstalled optional device, said determination of whether the uninstalled optional device can be additionally installed, and said display of the image are preformed with respect to said plurality of optional devices respectively.

5. The computer readable medium according to claim 1, wherein an interface window which comprises a basic settings window and a detail settings window, and which serves for the user to perform a setting operation for said target apparatus is provided by said information providing device; and
said display of said image representing the uninstalled optional device is performed on said basic settings window.

6. The computer readable medium according to claim 1, wherein said target apparatus is a printer, and said information providing device is a host device of the printer or the printer.

7. An information providing device that provides information relating to an optional device installable on a target apparatus,
said information providing device comprising:
an information acquisition unit which acquires information relating to an installation status of the optional device on said target apparatus, determines an uninstalled optional device, which is an installable optional device that has not been installed, and determines whether said uninstalled optional device can be additionally installed in the installation status in said target apparatus; and
an information display unit which displays an image representing said uninstalled optional device to a user so that possibility or impossibility of said additional installing can be identified.

8. A method for providing information in an information providing device that provides information relating to an optional device installable on a target apparatus,
said method comprising:
a step in which said information providing device acquires information relating to an installation status of the optional device on the target apparatus and determines an uninstalled optional device, which is an installable optional device that has not been installed;
a step in which said information providing device determines whether said uninstalled optional device can be additionally installed in the installation status in said target apparatus; and
a step in which said information providing device displays an image representing said uninstalled optional device to a user so that possibility or impossibility of said additional installing can be identified.
